(19) United States
(12) Patent Application Publication
(10) Pub. No.: US 2015/0198172 A1
(43) Pub. Date: Jul. 16, 2015

(54) DOUBLE MECHANICAL SEAL FOR CENTRIFUGAL PUMP

(71) Applicant: International Pump Solutions, Inc., Kingwood, TX (US)

(72) Inventors: Frank Joseph Hermmen, JR., Bayou Vista, TX (US); James Allen Johnson, The Woodlands, TX (US)

(21) Appl. No.: 14/578,367

(22) Filed: Dec. 20, 2014

Related U.S. Application Data
(60) Provisional application No. 61/919,353, filed on Dec. 20, 2013.

(51) Int. Cl. F04D 29/12; F16J 15/34; F04D 17/08; F16J 15/38

(52) U.S. Cl. CPC F04D 29/126; F16J 15/38; F16J 15/3452; F16J 15/3404; F04D 17/08

(57) ABSTRACT

A double mechanical seal assembly for sealing around the shaft of a centrifugal pump, a shaft sleeve that surrounds a portion of the shaft, and has an inner surface with a notch, the notch corresponding to a key on the shaft that engages the notch to transmit torque from the shaft to the shaft sleeve, an annular seal sleeve that surrounds the shaft sleeve and is engaged with the shaft sleeve, and rotating inboard outboard seals, each having a rotating seal face and operably associated. The seal assembly also includes stationary inboard and outboard seals each having a stationary seal face, the stationary seal face of the stationary inboard seal sealingly engaged with the rotating seal face of the rotating inboard seal and the stationary seal face of the stationary outboard seal sealingly engaged with the rotating seal face of the rotating outboard seal.

### RELATED APPLICATIONS

This application claims priority to and the benefit of U.S. Provisional Application No. 61/919,353, titled “Double Mechanical Seal Chamber for Pumps” and filed on Dec. 20, 2013, the contents of which are incorporated herein by reference in its entirety. This application is also related to U.S. patent application Ser. No. ______, titled “Coverplates for Centrifugal Pumps” and filed on Dec. 20, 2014, which claims priority to U.S. Provisional Application No. 61/919,274, the contents both of which are incorporated herein by reference in their entireties.

### BACKGROUND OF THE INVENTION

1. Field of the Invention

Embodiments disclosed herein relate to seals for use in pumps. In particular, embodiments disclosed herein relate to dual mechanical seals with novel cooling and axial adjustment capabilities.

2. Description of Related Art

Centrifugal pumps are often used in oilfield applications, such as, for example, to pump fluids into a wellbore during hydraulic fracturing operations. Typically, such centrifugal pumps include an impeller within a pump housing that rotates to drive fluids through the pump. The impeller is turned by a shaft that enters the pump housing through a stuffing box. A seal is employed at the interface between the shaft and the stuffing box, to prevent fluids from leaking from the pump.

Typically, the seals used in a centrifugal pump in a hydraulic fracturing operation have very tight tolerances between seal faces, and are cooled by the hydraulic fracturing fluid being pumped through the pump housing. The seal faces are typically very close together and have a very high coefficient of friction. One problem with relying on pumped fluid to cool the seal faces is that if there is even a minor loss of flow in the pump, the seal faces can very quickly heat up to a level that will destroy the seal. This problem can be exacerbated by an operator trying to reverse the damage by reintroducing cool fluid to the overheated seal surfaces, which can lead to cracking and further destruction of the surfaces. After such a failure of the seal, the only option to take the pump off-line and repair or replace the seal. Accordingly, one weakness of known pumps is that the seals can easily overheat based on operator error or otherwise.

In addition, the hydraulic fracturing fluids typically pumped at a well site are very abrasive and corrosive, which leads to wear on the impeller. As the impeller wears, a gap can form between the impeller and the pump housing, leading to inefficiencies in the pump. One solution to such impeller wear is to adjust the position of the impeller, by extending the shaft that turns the impeller, inwardly toward the pump housing, to close this gap. The problem with this solution, however, is the low tolerance of known seals to such a realignment of the shaft and impeller. Most seals are able to move axially only a few hundredths of an inch before the seal is compromised. Accordingly, a second weakness of known pumps is an inability to adjust the position of the shaft and impeller relative to the pump housing without damaging or destroying the seal.

Furthermore, because fluids pumped in hydraulic fracturing operations are abrasive, and often contain solid particles, such particles can get clogged or build up in the stuffing box around the axle. Such buildup can lead to seal damage because it can impede the flow of pumped fluid into the stuffing box to cool the seal. Accordingly, a third weakness of known pumps is the buildup of particles and other contaminates in the stuffing box.

### SUMMARY OF THE INVENTION

One embodiment of the present invention provides a double mechanical seal assembly for sealing around the shaft of a centrifugal pump, the centrifugal pump having a pump frame. The seal assembly includes an annular shaft sleeve that surrounds a portion of the shaft, the annular shaft sleeve having an inner surface with a notch, the notch corresponding to a key on the shaft that engages the notch to transmit torque from the shaft to the shaft sleeve, and an annular seal sleeve that surrounds at least a portion of the shaft sleeve and is engaged with the shaft sleeve so that as the shaft and the shaft sleeve rotate, the seal sleeve rotates. The seal assembly further includes a rotating inboard seal and a rotating outboard seal each having a rotating seal face and operably associated with the shaft sleeve so that as the shaft sleeve rotates, the rotating inboard seal and the rotating outboard seal rotate, as well as a stationary inboard seal and a stationary outboard seal each having a stationary seal face, the stationary seal face of the stationary inboard seal sealingly engaged with the rotating seal face of the rotating inboard seal and the stationary seal face of the stationary outboard seal sealingly engaged with the rotating seal face of the rotating outboard seal, the stationary inboard seal and stationary outboard seal decoupled from the shaft and the shaft sleeve so that they do not rotate as the shaft and the shaft sleeve rotate.

In some embodiments, the double mechanical seal assembly can further include a gland plate surrounding a portion of the shaft sleeve and fixedly attached to the pump frame, the gland plate having a coolant inlet port for injection of coolant into the seal assembly to help cool the inboard and outboard seal faces, and an outlet port to permit egress of coolant after circulation through the seal assembly. In addition, the seal assembly can include a spring holder surrounding the seal sleeve and axially positioned between the inboard seals and the outboard seals with an inboard end contacting the stationary inboard seal, the spring holder having a plurality of springs extending axially from an outboard end thereof, an outboard end of the springs fixed in position relative to the gland plate so that the springs push the spring holder axially in an inboard direction, in turn pushing the stationary inboard seal into sealing engagement with the rotating inboard seal. The springs can have sufficient tension to maintain sealed engagement between stationary inboard seal and the rotating inboard seal as the spring holder moves axially in an inboard direction relative to the gland plate.

In alternate embodiments the springs can have sufficient tension to maintain sealed engagement between stationary inboard seal and the rotating inboard seal as the spring holder moves up to at least about 0.25 inches in an inboard direction relative to the gland plate. Furthermore, the stationary inboard seal face and the rotating inboard seal face can be made of tungsten, the stationary outboard seal face can be made of carbon, and the rotating outboard seal face can be made of silicon carbide (SiC).

Another embodiment of the present invention provides a double mechanical seal assembly for sealing around the shaft of a centrifugal pump, the centrifugal pump having a pump frame. The seal assembly includes an annular shaft sleeve that surrounds a portion of the shaft and that is mechanically engaged with the shaft so that as the shaft rotates the shaft sleeve rotates, and an annular seal sleeve that surrounds at least a portion of the shaft sleeve and is engaged with the shaft sleeve so that as the shaft and the shaft sleeve rotate, the seal sleeve rotates. The seal assembly also includes a rotating inboard seal and a rotating outboard seal each having a rotating seal face and operably associated with the shaft sleeve so that as the shaft sleeve rotates, the rotating inboard seal and the rotating outboard seal rotate, as well as a stationary inboard seal and a stationary outboard seal each having a stationary seal face, the stationary seal face of the stationary inboard seal sealingly engaged with the rotating seal face of the rotating inboard seal and the stationary seal face of the stationary outboard seal sealingly engaged with the rotating seal face of the rotating outboard seal, the stationary inboard seal and stationary outboard seal decoupled from the shaft and the shaft sleeve so that they do not rotate as the shaft and the shaft sleeve rotate. Furthermore, the seal assembly includes a gland plate surrounding a portion of the shaft sleeve and fixedly attached to the pump frame, the gland plate having a coolant inlet port for injection of coolant into the seal assembly to help cool the inboard and outboard seal faces, and an outlet port to permit egress of coolant after circulation through the seal assembly.

In some example embodiments, the annular shaft sleeve can have an inner surface with a notch, the notch corresponding to a key on the shaft that engages the notch to transmit torque from the shaft to the shaft sleeve. In some embodiments, the seal assembly can further include a spring holder surrounding the seal sleeve and axially positioned between the inboard seals and the outboard seals with an inboard end contacting the stationary inboard seal, the spring holder having a plurality of springs extending axially from an outboard end thereof, an outboard end of the springs fixed in position relative to the gland plate so that the springs push the spring holder axially in an inboard direction, in turn pushing the stationary inboard seal into sealing engagement with the rotating inboard seal. The springs can have sufficient tension to maintain sealed engagement between stationary inboard seal and the rotating inboard seal as the spring holder moves axially in an inboard direction relative to the gland plate. In some instances, the springs can have sufficient tension to maintain sealed engagement between stationary inboard seal and the rotating inboard seal as the spring holder moves up to at least about 0.25 inches in an inboard direction relative to the gland plate.

In some embodiments, the stationary inboard seal face and the rotating inboard seal face can be made of tungsten, the stationary outboard seal face can be made of carbon, and the rotating outboard seal face can be made of silicon carbide (SiC).

Yet another embodiment of the invention provides a double mechanical seal assembly for sealing around the shaft of a centrifugal pump, the centrifugal pump having a pump frame. The seal assembly includes an annular shaft sleeve that surrounds a portion of the shaft and that is mechanically engaged with the shaft so that as the shaft rotates the shaft sleeve rotates, and an annular seal sleeve that surrounds at least a portion of the shaft sleeve and is engaged with the shaft sleeve so that as the shaft and the shaft sleeve rotate, the seal sleeve rotates. The seal assembly further includes a rotating inboard seal and a rotating outboard seal each having a rotating seal face and operably associated with the shaft sleeve so that as the shaft sleeve rotates, the rotating inboard seal and the rotating outboard seal rotate, as well as a stationary inboard seal and a stationary outboard seal each having a stationary seal face, the stationary seal face of the stationary inboard seal sealingly engaged with the rotating seal face of the rotating inboard seal and the stationary seal face of the stationary outboard seal sealingly engaged with the rotating seal face of the rotating outboard seal, the stationary inboard seal and stationary outboard seal decoupled from the shaft and the shaft sleeve so that they do not rotate as the shaft and the shaft sleeve rotate.

Furthermore, the seal assembly includes a gland plate surrounding a portion of the shaft sleeve and fixedly attached to the pump frame, and a spring holder surrounding the seal sleeve and axially positioned between the inboard seals and the outboard seals with an inboard end contacting the stationary inboard seal, the spring holder having a plurality of springs extending axially from an outboard end thereof, an outboard end of the springs fixed in position relative to the gland plate so that the springs push the spring holder axially in an inboard direction, in turn pushing the stationary inboard seal into sealing engagement with the rotating inboard seal. The springs have sufficient tension to maintain sealed engagement between stationary inboard seal and the rotating inboard seal as the spring holder moves axially in an inboard direction relative to the gland plate.

In some embodiments, the springs can have sufficient tension to maintain sealed engagement between stationary inboard seal and the rotating inboard seal as the spring holder moves up to at least about 0.25 inches in an inboard direction relative to the gland plate. In addition, the annular shaft sleeve can have an inner surface with a notch, the notch corresponding to a key on the shaft that engages the notch to transmit torque from the shaft to the shaft sleeve.

In some alternate embodiments, the gland plate can have a coolant inlet port for injection of coolant into the seal assembly to help cool the inboard and outboard seal faces, and an outlet port to permit egress of coolant after circulation through the seal assembly. Furthermore, the stationary inboard seal face and the rotating inboard seal face can be made of tungsten, the stationary outboard seal face can be made of carbon, and the rotating outboard seal face can be made of silicon carbide (SiC).

Other embodiments of the present invention provide a stuffing box for a centrifugal pump. The stuffing box includes an inboard side for engagement with a pump housing of the centrifugal pump, an outboard side opposite the inboard side, and a passageway between the inboard side and outboard side of the stuffing box, the passageway for insertion of the shaft and a portion of the seal assembly. The passageway has an inner passageway surface that includes ribs formed in the inner passageway surface and extending inwardly from the inner passageway surface toward the shaft. The ribs are arranged circumferentially around the inner passageway surface.

### BRIEF DESCRIPTION OF THE DRAWINGS

The present technology will be better understood on reading the following detailed description of nonlimiting embodiments thereof, and on examining the accompanying drawings, in which:

FIG. 1 shows a top view of a centrifugal pump according to an embodiment of the present invention;

FIG. 2 shows an isometric exploded view of the pump of FIG. 1;

FIG. 3A shows a side view of a stuffing box according to an embodiment of the present invention;

FIG. 3B shows a cross-sectional view of the stuffing box of FIG. 3A taken along line 3B-3B;

FIG. 3C shows a cross-sectional view of the stuffing box of FIG. 3A taken along line 3C-3C;

FIG. 3D shows a cropped view of the passageway and ribs of the stuffing box of FIGS. 3A-3C;

FIG. 4 shows a side cross-sectional view of a seal assembly according to an embodiment of the present invention taken along line 4-4 of FIG. 2;

FIG. 5A is a side view of the seal assembly of FIG. 4;

FIG. 5B is an end view of the seal assembly of FIG. 5A;

FIG. 6A is an end view of the shaft sleeve according to an embodiment of the present invention;

FIG. 6B is a side cross-sectional view of the shaft sleeve of FIG. 6A taken along line 6B-6B;

FIG. 6C is an alternate end view of the shaft sleeve of FIGS. 6A and 6B;

FIG. 7A is an end view of a seal sleeve according to an embodiment of the present invention;

FIG. 7B is a side cross-sectional view of the seal sleeve of FIG. 7A;

FIG. 7C is an alternate end view of the seal sleeve of FIGS. 7A and 7B;

FIG. 7D is an enlarged side cross-sectional view of a portion of the seal sleeve of FIG. 7B indicated by area 7D;

FIG. 8A is a side cross-sectional view of a rotating inboard seal carrier according to an embodiment of the present invention;

FIG. 8B is an end view of the rotating inboard seal carrier of FIG. 8A;

FIG. 8C is an enlarged side cross-sectional view of a portion of the rotating inboard seal carrier of FIG. 8A, as indicated by area 8C;

FIG. 8D is an end view of a rotating inboard seal;

FIG. 8E is a side view of the rotating inboard seal of FIG. 8D;

FIG. 9A is an end view of a stationary inboard seal carrier according to an embodiment of the present invention;

FIG. 9B is a side cross-sectional view of the stationary inboard seal carrier of FIG. 9A taken along line 9B-9B;

FIG. 9C is an enlarged side cross-sectional view of a portion of the stationary inboard seal carrier of FIG. 9B as indicated by area 9C;

FIG. 9D is an end view of a stationary inboard seal;

FIG. 9E is a side view of the stationary inboard seal of FIG. 9D;

FIG. 10A is an end view of a spring holder according to an embodiment of the present invention;

FIG. 10B is a side cross-sectional view of the spring holder of FIG. 10A taken along line 10B-10B;

FIG. 10C is an enlarged side-cross-sectional view of the spring holder of FIG. 10A taken along line 10C-10C;

FIG. 10D is a side view of the spring holder of FIGS. 10A-10C;

FIG. 11A is an end view of a gland plate according to an embodiment of the present invention;

FIG. 11B is a side cross-sectional view of the gland plate of FIG. 11A taken along line 11A-11A;

FIG. 11C is a side cross-sectional view of the gland plate of FIG. 11A taken along line 11C-11C;

FIG. 11D is a side cross-sectional view of the gland plate of FIG. 11A taken along line 11D-11D;

FIG. 11E is an enlarged side cross-sectional view of a portion of the gland plate shown in FIG. 11B as indicated by area 11E;

FIG. 12A is an end view of a snap ring according to an embodiment of the present invention;

FIG. 12B is a side view of the snap ring of FIG. 12A;

FIG. 13A is an end view of a spacer according to an embodiment of the present invention;

FIG. 13B is a side view of the spacer of FIG. 13A;

FIG. 14A is a side view of a stationary outboard seal carrier according to an embodiment of the present invention;

FIG. 14B is an end view of the stationary outboard seal carrier of FIG. 14A;

FIG. 14C is an end view of a stationary outboard seal;

FIG. 14D is a side view of the stationary outboard seal of FIG. 14C;

FIG. 15A is an end view of a rotating outboard seal carrier according to an embodiment of the present invention;

FIG. 15B is a side cross-sectional view of the rotating outboard seal carrier of FIG. 15A taken along line 15B-15B;

FIG. 15C is an end view of a rotating outboard seal;

FIG. 15D is a side view of the rotating outboard seal of FIG. 15C;

FIG. 16A is an end view of a drive collar according to an embodiment of the present invention;

FIG. 16B is a side cross-sectional view of the drive collar of FIG. 16A taken along line 16B-16B; and

FIG. 16C is a side cross-sectional view of the drive collar of FIG. 16A taken along line 16C-16C.

### DETAILED DESCRIPTION OF THE PREFERRED EMBODIMENT

The foregoing aspects, features, and advantages of the present technology will be further appreciated when considered with reference to the following description of preferred embodiments and accompanying drawings, wherein like reference numerals represent like elements. The following is directed to various exemplary embodiments of the disclosure. The embodiments disclosed should not be interpreted, or otherwise used, as limiting the scope of the disclosure, including the claims. In addition, those having ordinary skill in the art will appreciate that the following description has broad application, and the discussion of any embodiment is meant only to be exemplary of that embodiment, and not intended to suggest that the scope of the disclosure, including the claims, is limited to that embodiment.

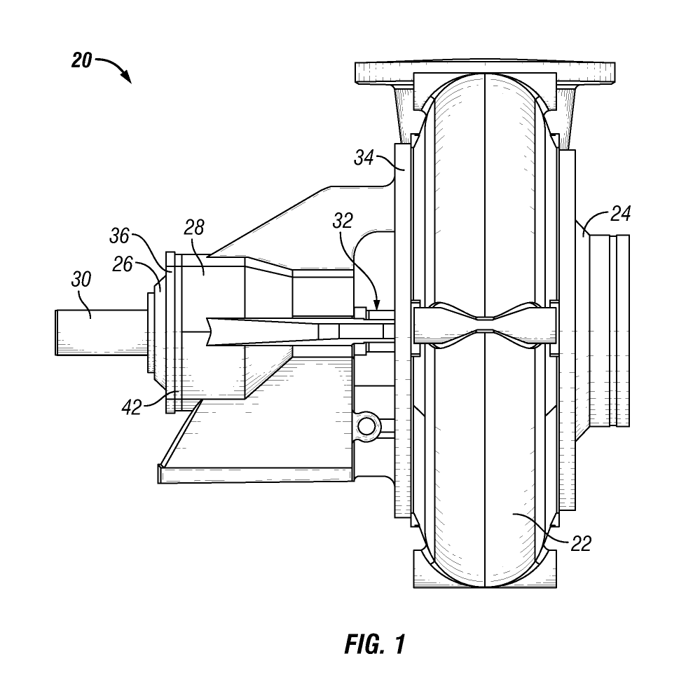

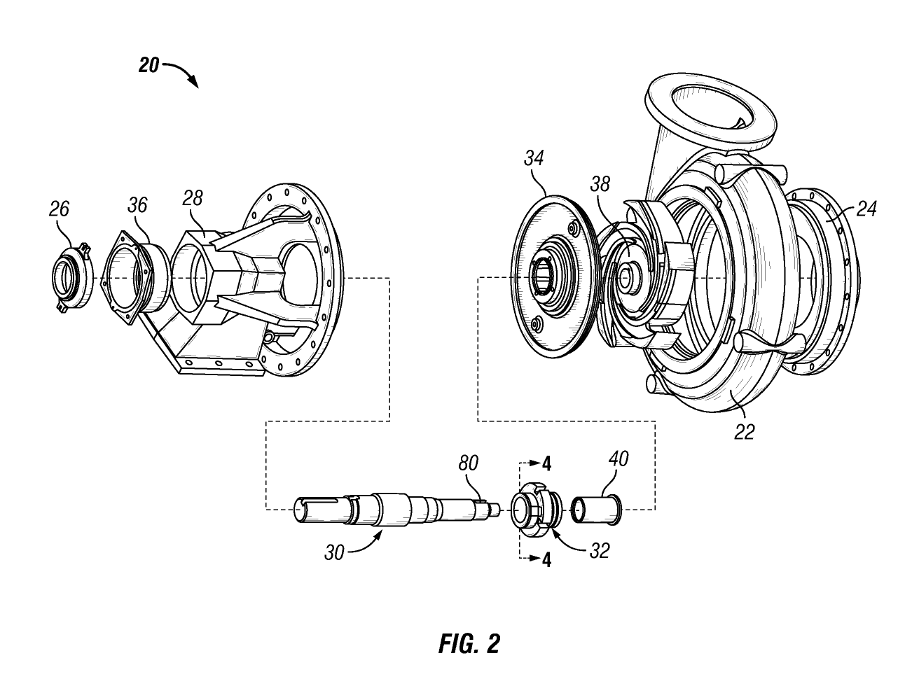

FIG. 1 depicts a top view of a pump 20 according to an embodiment of the present invention. The pump 20 includes a pump housing 22 and a front cover 24, as well as a bearing cover 26, frame 28, and shaft 30. The pump 20 also includes a seal 32 and a stuffing box 34. The shaft extends through the bearing cover 26 and a bearing housing 36 (shown in FIG. 2) in the frame 28, as well as the seal 32 and the stuffing box 34 where it attaches to an impeller 38 (also shown in FIG. 2) disposed within the pump housing 22. The shaft serves to turn the impeller 38, which moves fluid through the pump. The pumped fluid can include, for example, hydrocarbons and sand that are used in hydraulic fracturing operations.

In the exploded view of FIG. 2, the components, including some internal components, of the pump 20 are shown. In operation, the pump 20 receives fluid through a pipe (not shown) connected to the front cover 24. The fluid enters the pump housing 22 through the front cover 24 and comes into contact with the impeller 38. The impeller rotates within the pump housing 22 to drive fluid through the pump 20. As shown in FIGS. 1 and 2, the shaft 30 that drives the impeller 38 passes through the stuffing box 34 attached to the pump housing 22 to the impeller 38. It is necessary to seal the interface between the shaft 30 and the stuffing box 34 to prevent the egress of fluid from the pump housing 22. This is accomplished by the use of the seal 32 in conjunction with a shaft sleeve 40 positioned between the seal 32 and the shaft 30.

The seal 32 and shaft sleeve 40 of the present invention serve to seal the interface between the shaft 30 and the stuffing box 34, while simultaneously allowing for adjustment of the seal 32 relative to the shaft 30 without compromising the integrity of the seal 32. This feature is advantageous because over time as the pump operates, due to the abrasive nature of the fluids in the pump, the impeller 38 wears. As it wears, the impeller 38 can become somewhat loose in the pump housing 22. For example, a gap may form between the side of the impeller 38 and the pump housing 22, leading to inefficiencies in the pump. In the pump 20 of the embodiment shown in FIG. 1, the position of the impeller 38 relative to the pump housing 22 can be adjusted by adjusting the position of the shaft 30.

For example, as shown in FIG. 1, the shaft 30 is axially fixed relative to the bearing housing 36, which is in turn fastened to the frame 28 of the pump 20. Initially, when the impeller 38 is new, the shaft 30 and bearing cover 26 may be positioned so that there is a space 42 between the bearing housing 36 and the frame 28. As the impeller 38 wears, however, it may become necessary to adjust the position of the impeller 38 relative to the pump housing 22. To accomplish this, the space 42 can be reduced or eliminated by moving the bearing housing 36 toward the frame 28. This can be accomplished, for example, by tightening fasteners that attach the bearing housing 36 to the frame 28. As the bearing housing 36 moves toward the frame 28, the shaft moves axially toward the pump housing 22 and in turn repositions the impeller 38 within the pump housing 22 to close the gap between the impeller 38 and the pump housing 22. As the shaft 30 moves toward the pump housing 22, the seal 32 of the present invention is capable of axial movement along with the shaft 30 without losing the integrity of the seal 32. In some embodiments the shaft 30 and seal 32 can move axially up to about 0.25 inch or more.

In addition, as described in more detail below, the seal 32 of the present invention includes a secondary cooling mechanism to avoid the problems that many known seals face as a result of reduced fluid flow through the pump, or dead-heading. This secondary cooling mechanism circulates fluid between the seal surface to help cool the seal surfaces even in the absence of pumped fluid.

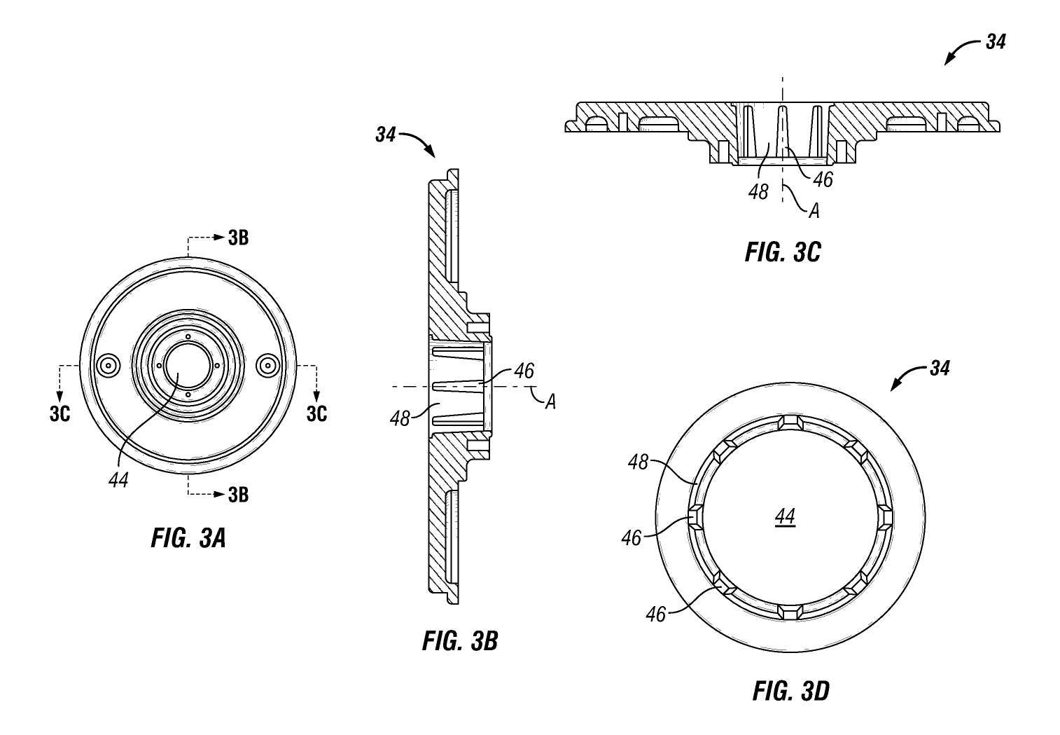

Referring now to FIGS. 3A-3D, there are shown more detailed views of the stuffing box 34. The stuffing box 34 is designed to enclose the frame side of the pump 20 (as shown in FIG. 1), and include a central passage 44 through which the shaft 30 passes and in which the shaft sleeve 40 and seal 32 at least partially reside. In the embodiment depicted in FIGS. 3A-3D, there are ribs 46 that protrude inwardly from inner surface 48 of the central passage 44 toward the central axis A of the central passage 44. The ribs 46 can be spaced circumferentially around the inner surface 48.

One purpose of the ribs 46 of the stuffing box is to prevent particles in the pumped fluid from accumulating inside the stuffing box. In the absence of ribs 46, such an accumulation of particles can occur over time and the density of the particles can eventually reach a point where fluid cannot adequately access and cool the surfaces of the seal 32. This can lead to problems of the seal 32 overheating and ultimately being damaged. The ribs 46 act to prevent the buildup of harmful particles by increasing turbulence in the stuffing box 34, and physically breaking up large particles that may otherwise become wedged or stuck in central passage 44 of the stuffing box 34.

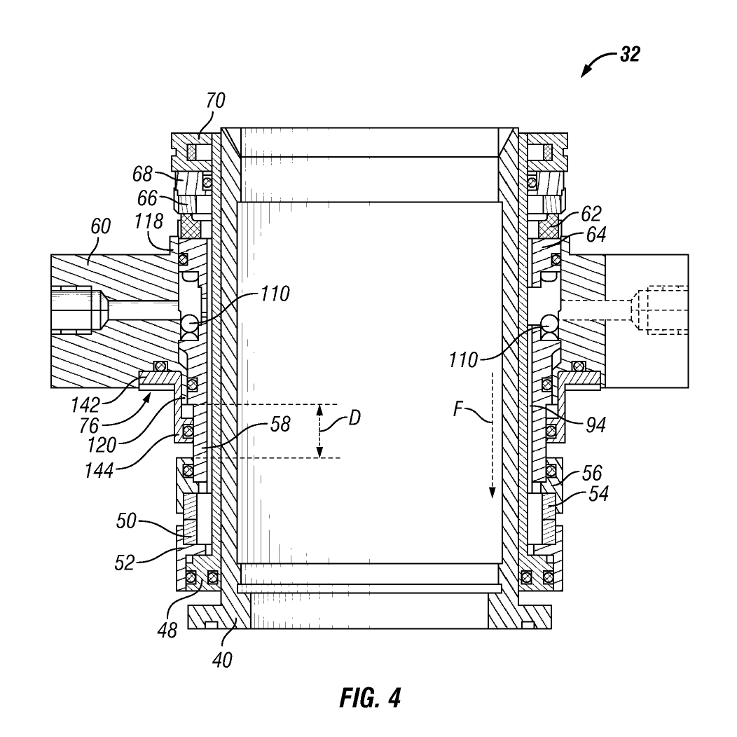

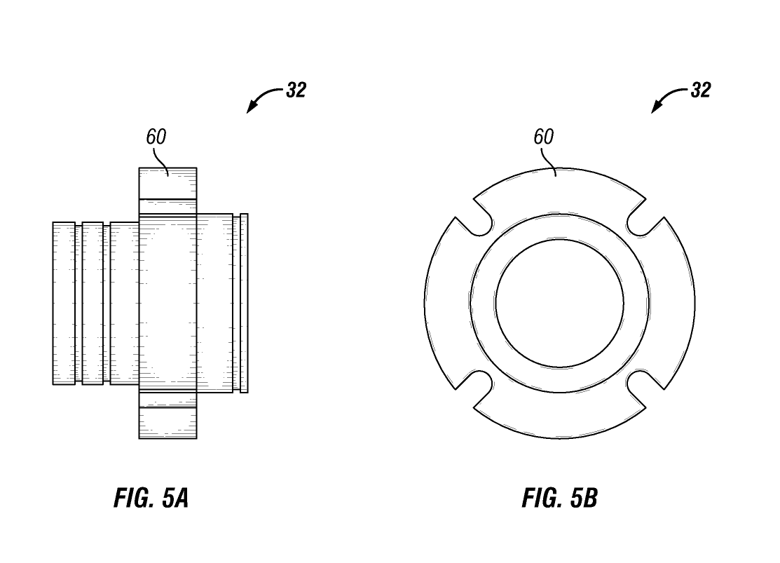

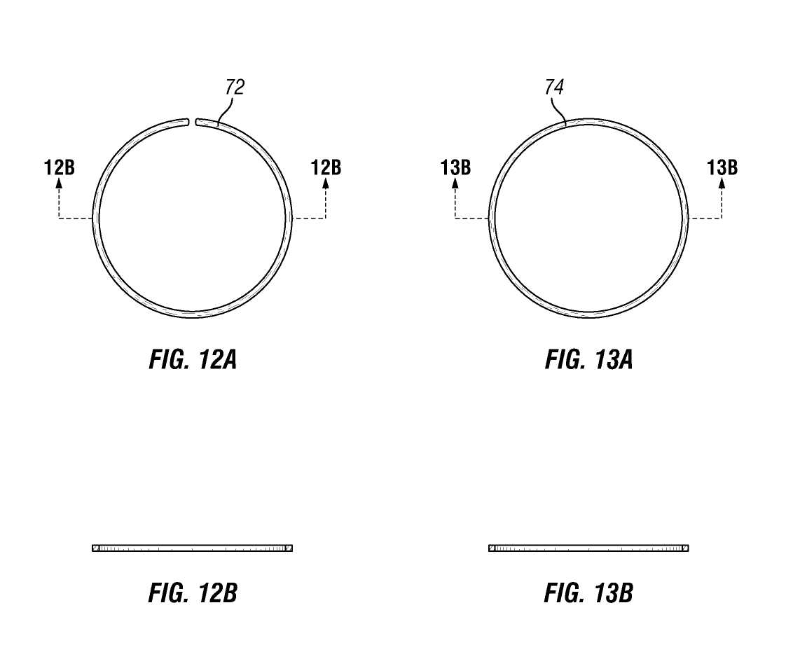

FIG. 4 shows the seal 32 assembly and shaft sleeve 40, include individual components of the seal 32. The arrangement of seal components that make up the seal 32 help to provide the ability of the seal 32 to move relative to the stuffing box 34 and pump housing 22 to allow adjustment of a worn impeller 38, as discussed above. In particular, the seal 32 assembly shown in FIG. 4 includes the shaft sleeve 40, the seal sleeve 48, the rotating inboard seal 50 and rotating inboard seal carrier 52, the stationary inboard seal 54 and stationary inboard seal carrier 56, the spring holder 58, the gland plate 60, the stationary outboard seal 62 and stationary outboard seal carrier 64, the rotating outboard seal 66 and rotating outboard seal carrier 68, and the drive collar 70. Additional components included in the assembly are a snap ring 72 (shown in FIGS. 12A and 12B) and spacer rings 74 (shown in FIGS. 13A and 13B). The seal 32 assembly also includes a pin 76 that attaches to the gland plate 60 and limits movement of the seal 32 relative to the gland plate 60. FIGS. 5A and 5B show the seal 32, including the gland plate 60 in a more schematic form.

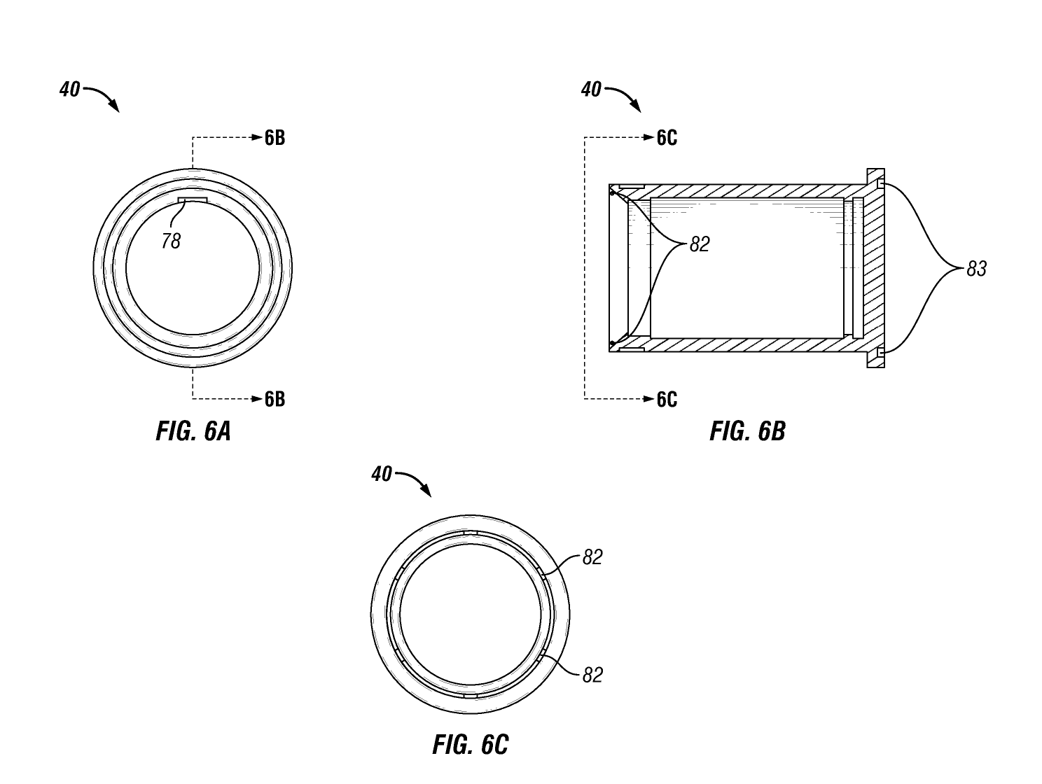

FIGS. 6A-6C show the shaft sleeve 40 according to an example embodiment of the present invention. As can be seen in FIG. 6A, the shaft sleeve 40 includes a notch 78 in an inner surface thereof. The notch 78 of the shaft sleeve 40 corresponds to a protrusion 80 (shown in FIG. 2) on the shaft 30 and acts as a torque transfer mechanism. That is, when the shaft 30 turns, the protrusion 80 engages the notch 78 of the shaft sleeve 40, and causes the shaft sleeve 40 to turn with the shaft 30. The shaft sleeve 40 also includes indents 82 for engagement with set screws that may be used, for example, to engage the shaft sleeve 40 with the seal sleeve 48. Furthermore, the shaft sleeve 40 includes seals 83, which can be elastomeric, and can help seal the interface between the shaft sleeve 40 and adjacent components of the pump 20.

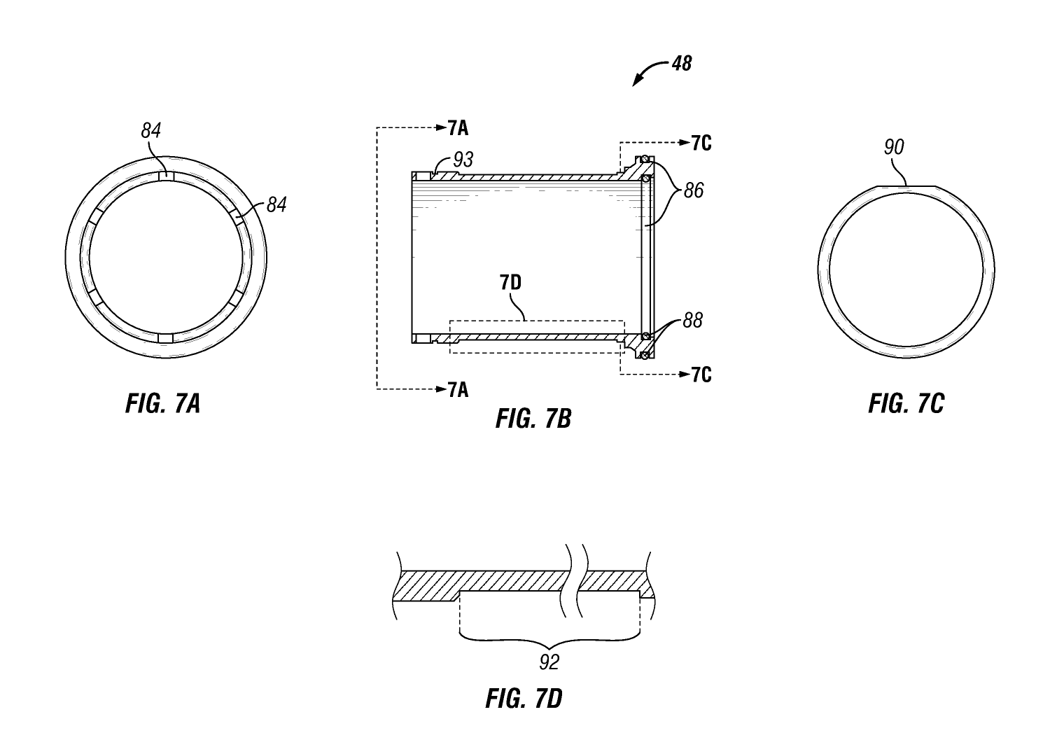

FIGS. 7A-7D depict the seal sleeve 48 according to one embodiment of the present invention. The seal sleeve 48 is designed to substantially surround the shaft sleeve 40, as shown in FIG. 4, and to rotate with the shaft sleeve 40 and the shaft 30. To this end, torque is transferred to the seal sleeve 48 via set screws (not shown) that pass through apertures 84 in the wall of the seal sleeve 48, and into engagement with the indents 82 of the shaft sleeve 40 (shown in FIG. 6C).

The seal sleeve 48 also includes grooves 86 for accepting seals 88. Seals 88 can be elastomeric, and can serve to seal the interface between the seal sleeve 48 and the shaft sleeve 40, as well as the interface between the seal sleeve 48 and the rotating inboard seal carrier 52. Another feature of the seal sleeve 48 is a flattened portion 90 on the outer surface of the seal sleeve 48. This flattened portion 90 is designed to interact with, and transmit torque to, a corresponding flattened feature 91 on the inner surface of the rotating inboard seal carrier 52. Yet another feature of the seal sleeve 48 is an indented portion 92 of its outer diameter. One purpose for this indented portion 92 is to ensure that, once the seal 32 is fully assembled, there is a gap 94 (shown in FIG. 4) between the seal sleeve 48, which rotates with the shaft 30, and stationary components of the seal 32, such as the spring holder 58 and the stationary seals and carriers. In addition, the seal sleeve 48 includes a snap ring groove 93 for receiving the snap ring 72 during assembly of the seal 32.

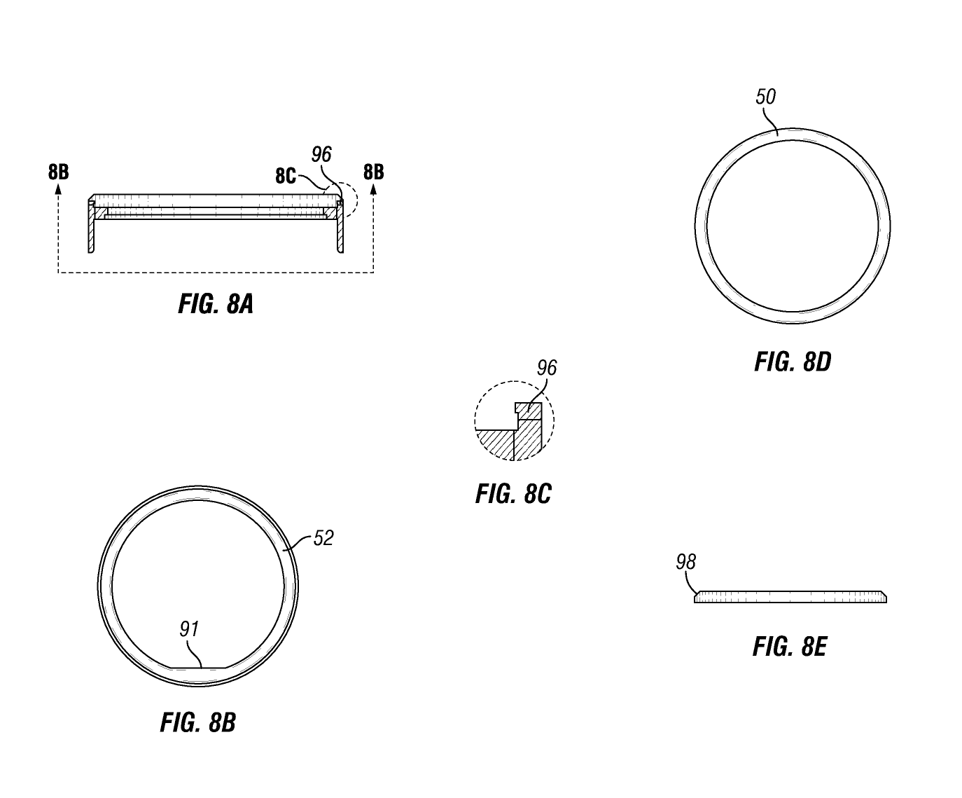

FIGS. 8A and 8B show the rotating inboard seal carrier 52, including the flattened feature 91 on its inner surface that engages the flattened portion 90 of the outer surface of the seal sleeve 48. Via this flattened feature 91, the seal sleeve 48 transfers torque to the rotating inboard seal carrier 52 so that it rotates along with the shaft 30, shaft sleeve 40, and seal sleeve 48. The rotating inboard seal carrier 52 further includes an annular gripping protrusion 96 configured to accept the rotating inboard seal 50. The rotating inboard seal 50 is shown in FIGS. 8D and 8E. This seal can be made of tungsten, or any other appropriate material. In addition, an outer edge 98 of the rotating inboard seal 50 may be chamfered.

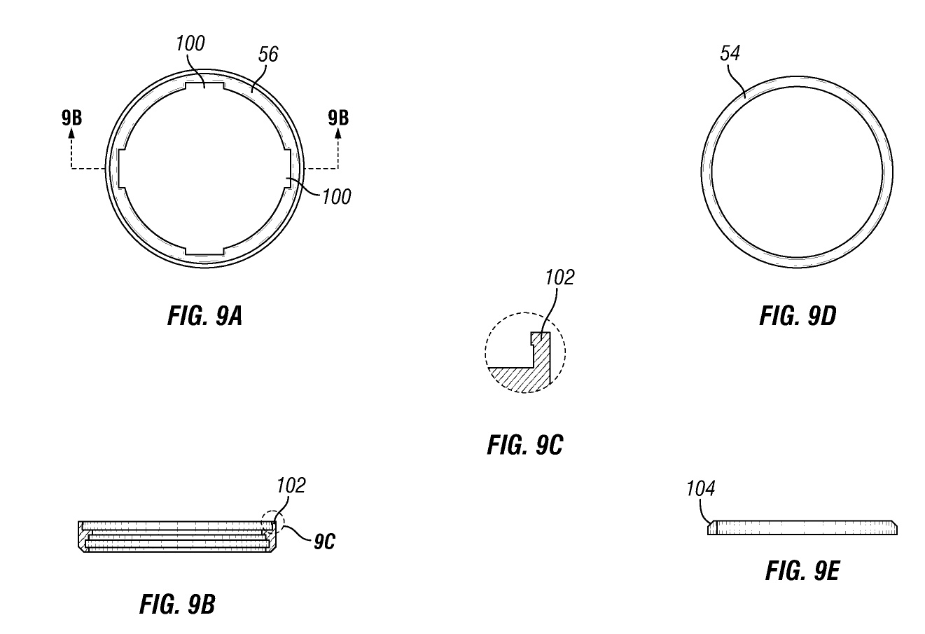

Referring now to FIGS. 9A-9C, there is shown the stationary inboard seal carrier 56. Stationary inboard seal carrier 56 can include notches 100 around the inner surface thereof. One purpose of the notches 100 may be to accept corresponding protrusions on the spring holder 58 in order keep the stationary inboard seal carrier 56 stationary, and to prevent it from rotating relative to the spring holder 58. The stationary inboard seal carrier 56 further includes an annular gripping protrusion 102 configured to accept the stationary inboard seal 54. The stationary inboard seal 54 is shown in FIGS. 9D and 9E. This seal can be made of tungsten, or any other appropriate material. In addition, an inner edge 104 of the stationary inboard seal 54 may be chamfered. When the seal 32 is fully assembled, the surface of the rotating inboard seal 50 and the surface of the stationary inboard seal 54 make up the inboard seal surfaces.

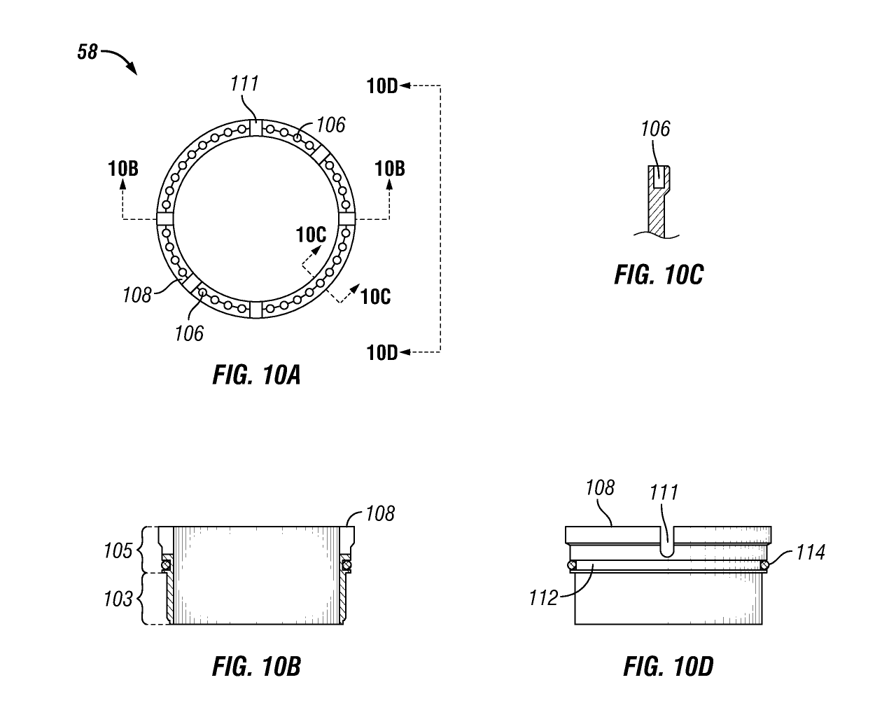

FIGS. 10A-10D depict the spring holder 58. The spring holder 58 is an annular member that surrounds the seal sleeve 48, and is attached to the gland plate 60, discussed below. The outer surface of the spring holder 58 is stepped, as shown in FIG. 10B, having a relatively smaller outer diameter along a first portion 103, and relatively larger diameters along second portion 105. As shown in FIGS. 10A and 10C, the spring holder 58 also has a plurality of holes 106 arranged circumferentially around a top surface 108 that extend axially into the body of the spring holder 58. These holes 106 each receive a spring 110 (shown in FIG. 4). Upon assembly, the springs are compressed using a jig (not shown) and then held in place relative to the gland plate 60 using the snap ring 72. The springs 110 to exert a force F (shown in FIG. 4) in a direction toward the inboard seal, and this force F pushes the surface of the stationary inboard seal 54 against the surface of the rotating inboard seal 50 to create a face seal. In addition to the holes 106, the spring holder 58 further includes a circumferential groove 112 for accepting an O-ring seal 114, as shown in FIG. 10D. The O-ring seal 114 serves to help seal the interface between the spring holder 58 and the gland plate 60. In addition, the spring holder 58 includes notches 111 in the top surface 108 thereof. The purpose of the notches 111 is to accept fasteners (not shown) for attaching the spring holder 58 to the gland plate 60 so that the spring holder 58 does not rotate relative to the gland plate 60.

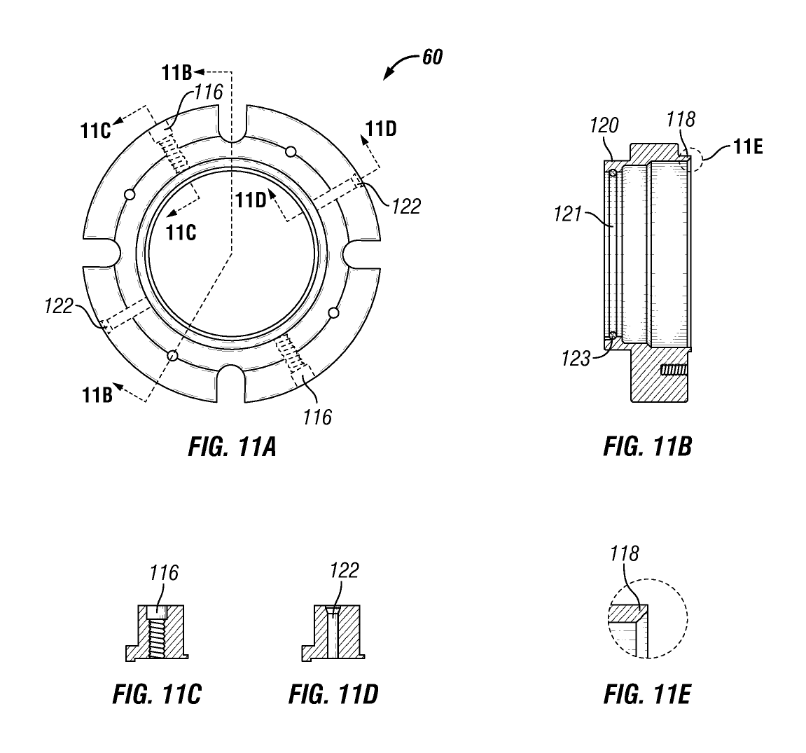

Referring to FIGS. 11A-11E, there is shown the gland plate 60 according to an example embodiment of the invention. The gland plate 60 is designed to be fixedly attached to the frame 28 of the pump 20. As shown in FIGS. 11A and 11C, the gland plate 60 includes apertures 116 for receiving fasteners (not shown). As described above, the fasteners in the gland plate 60 extend inwardly through the gland plate 60 and engage the notches 111 in the spring holder 58 to prevent the spring holder 58 from rotating relative to the gland plate 60. In addition, as shown in FIGS. 11B and 11E, the gland plate includes an outer annular protrusion 118 and an inner annular protrusion 120. The outer annular protrusion 118 extends away from the inboard seal, as shown in FIG. 4, and surrounds the outboard seal carrier 64. The inner annular protrusion 120 extends toward the inboard seal, also as shown in FIG. 4, and surrounds a portion of the spring holder 58. The gland plate further includes a circumferential recess 121 configured to accept an O-ring seal 123. This O-ring seal can help seal the interface between the gland plate 60 and the spring holder 58.

Another feature of the gland plate, which is best shown in FIGS. 11A and 11D, is a pair of coolant ports 122. In practice, a coolant source can be connected to one of the coolant ports 122 to inject coolant through the coolant port 122. The coolant source may be, for example, a barrier fluid tank mounted somewhere near the blender pump at a well site. The barrier fluid, or coolant, can be any fluid that is compatible with the pumped fluid. As coolant is supplied to the inside of the gland plate 60 through the coolant port 122, is enters the gap 94 between the seal sleeve 48 and the stationary components of the seal 32. The coolant can travel in the gap 94 until it reaches the inboard and outboard seal surfaces, which it can help to cool. The coolant channels heat away from the seal surfaces and exits via the alternate cooling port 122. Although two cooling ports 122 are shown in the gland plate 60 of the embodiment of FIGS. 11A-11E, any number of cooling ports can be used. The ability to cool the seal 32 via the cooling ports in the gland plate 60 is advantageous for a number of reasons.

For example, in most known pumps used to pump heavy fluid slurries that are corrosive and abrasive, such as many fluids commonly used in hydraulic fracturing operations, the abrasive nature of the slurry leads to seal face combinations that have a very high coefficient of friction. At the same time, the faces of the seal are typically cooled by the fluid being pumped. As a result, if a fluid running into the pump stops, such as due to the fluid source running dry, the resultant lack of fluid at the seal surfaces can very quickly lead to heat spikes at the seal faces and failure of the seals. This problem can be compounded if an operator, realizing the problem, suddenly reintroduces fluid to the seal surfaces, thereby causing the seal faces to crack due to the large temperature differentials. This problem is often encountered in the field, for example, if an operator does not shut the blender down soon enough when the pump 20 is shut down.

The cooling ports 122 in the gland plate 60 of the present invention alleviate this problem by providing a secondary coolant source. Thus, if pumping fluid stops cooling the seal surfaces, the coolant provided through the cooling ports 122 in the gland plate 60 can temporarily cool the seal surfaces and preserve the seal 32. This cooling mechanism can therefore save time and money spent servicing or replacing ruined seals in the field.

FIGS. 12A and 12B show the snap ring 72 that can be used to hold the springs 110 in a compressed condition relative to the rotating seal 32 components, as discussed in greater detail below. The snap ring 72 is split, so that its diameter can be reduced during insertion. FIGS. 13A and 13B show a spacer 74 that can be inserted in the seal 32 assembly as needed to adjust the spacing between components. Both the snap ring 72 and the spacer 74 can be installed on the outboard side of the rotating outboard seal carrier 68.

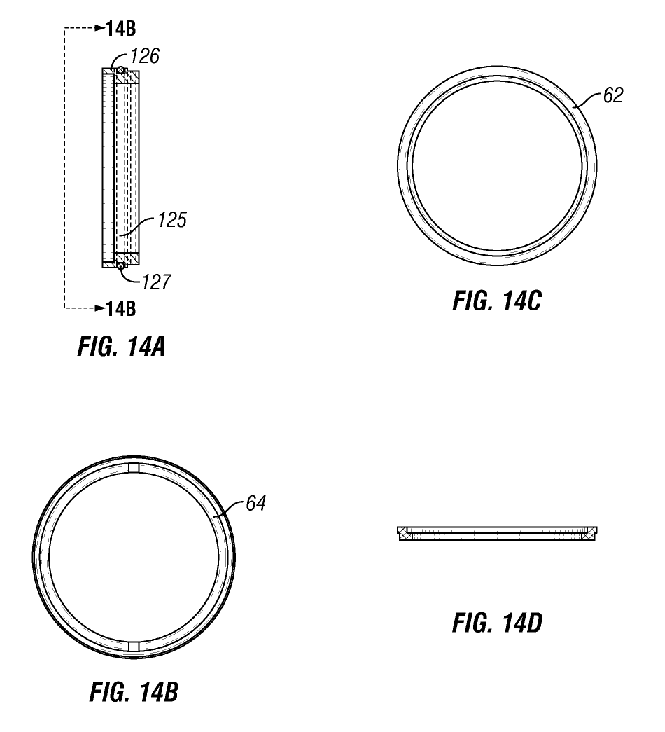

Referring to FIGS. 14A and 14B, there is shown the stationary outboard seal carrier 64. Upon insertion into the assembly, the inboard side of the stationary outboard seal carrier 64 can contact the springs 110 in the spring holder 58, so that when the stationary outboard seal carrier 64 is pushed in an inboard direction relative to the spring holder 58 and the gland plate 60, the springs 110 are compressed. The stationary outboard seal carrier 64 is also circumscribed by a recess 125 configured to accept an O-ring 127. The stationary outboard seal carrier 64 further includes an annular gripping protrusion 126 configured to accept the stationary outboard seal 62. The stationary outboard seal 62 is shown in FIGS. 14C and 14D. This seal can be made of carbon, or any other appropriate material. In addition, the stationary outboard seal 62 can be stepped. One purpose of the stepped profile of the stationary outboard seal 62 may be to increase the surface area of the seal 62.

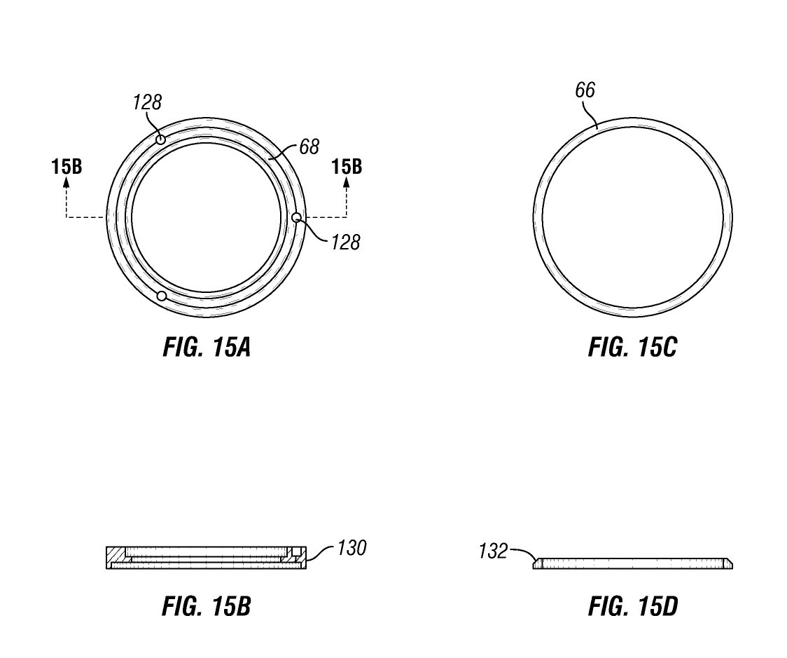

FIGS. 15A and 15B show the rotating outboard seal carrier 68, including holes 128 for receiving fasteners to fasten the outboard seal carrier 68 to the drive collar 70. Via these fasteners, the drive collar 70 transfers torque to the rotating outboard seal carrier 68 so that it rotates along with the shaft 30, shaft sleeve 40, seal sleeve 48, and drive collar 70. The rotating outboard seal carrier 68 further includes an annular gripping protrusion 130 configured to accept the rotating outboard seal 66. The rotating outboard seal 66 is shown in FIGS. 15C and 15D. This seal can be made of tungsten, or any other appropriate material. In addition, an outer edge 132 of the rotating outboard seal 66 may be chamfered. When the seal 32 is fully assembled, the surface of the rotating outboard seal 66 and the surface of the stationary outboard seal 62 make up the outboard seal surfaces.

Referring back to FIGS. 12A and 12B, which show the snap ring 72 and spacer 74. The spacer can be installed in the assembly on the outboard side of the rotating outboard seal carrier. Then, the spacer ring can be installed on the outboard side of the snap ring 72, followed by the drive collar 70, as discussed below.

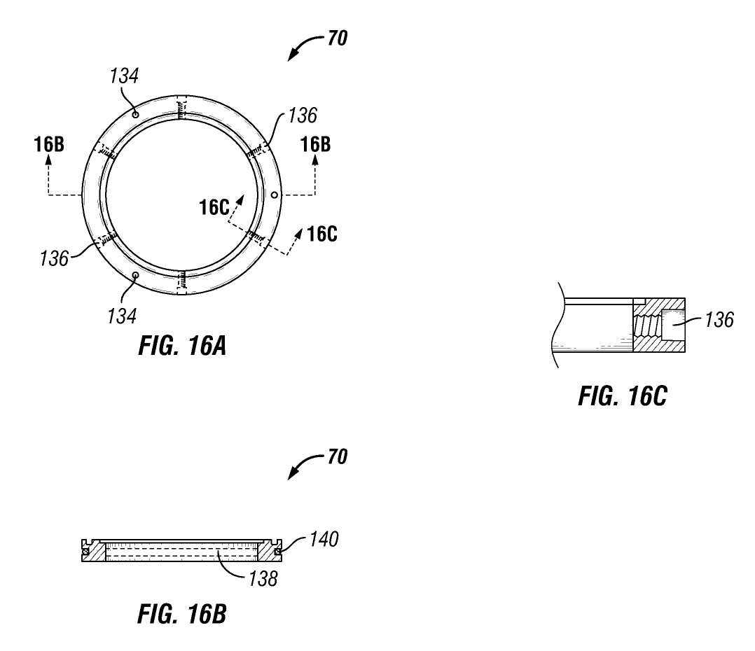

Referring now to FIGS. 16A-16C, there is shown a drive collar 70 according to an embodiment of the present invention. The drive collar 70 includes axial apertures 134 around the circumference thereof to accept fasteners that may be used to fasten the drive collar 70 to the rotating outboard seal 66. The fasteners may be any type of appropriate fastener, including threaded or unthreaded fasteners. The drive collar 70 also includes radial apertures 136 to accept fasteners that may be used to fasten the drive collar 70 to the seal sleeve 48, thereby allowing the seal sleeve 48 to transmit torque to the drive collar 70. The drive collar 70 is circumscribed by a recess 138 that accepts an O-ring seal 140. One purpose of the O-ring seal is to seal the interface between the drive collar 70 and other components of the pump 20.

Assembly of the seal can be accomplished by the following method. The rotating inboard seal 50 and carrier 52 is placed over the seal sleeve 48. The stationary inboard seal 54 and carrier 56 is then placed over the seal sleeve 48 so that the stationary inboard seal 54 faces the rotating inboard seal. Next, the spring holder 58 can be attached to the gland plate 60, and both components can be placed over the seal sleeve 48 until the spring holder 58 engages the stacked inboard seal carriers 52, 56. The springs 110 can then be installed in the spring holder 58, followed by the stationary outboard seal 62 and carrier 64 and the rotating outboard seal 66 and carrier 68, respectively. Next, the spacer 74 can be installed, followed by the snap ring 72. The springs 110 can be compressed using a jig, which pushes the snap ring 72 inwardly in an inboard direction until the snap ring 72 engages the snap ring groove 93 in the seal sleeve 48. Finally, the drive collar 70 can be placed over the seal sleeve 48.

Referring back to FIG. 4, it can therefore be seen that rotating components of the seal 32 (e.g., the shaft sleeve 40, seal sleeve 48, rotating inboard seal 50 and carrier 52, rotating outboard seal 66 and carrier 68, and drive collar 70) are free to rotate relative to the stationary components of the seal 32 (e.g., the stationary inboard seal 54 and carrier 56, spring holder 58, gland plate 60, and stationary outboard seal 62 and carrier 64). Furthermore, each of the stationary components of the seal 32 can move axially relative to the gland plate 60 a predetermined distance. This distance is controlled by the pin 76, which attaches to the gland plate 60 at a first pin end 142, and steps inward toward the spring holder 105 at a second pin end 144. In the embodiment shown in FIG. 4, the diameter of the pin 76 at the second pin end 144 is similar to the diameter of the outer surface of the first portion 103 of the spring holder 58.

Thus positioned, the pin 76 limits the movement of the stationary components of the seal 32 relative to the gland plate. Specifically, the seal 32 is limited in its movement away from the pump housing 22 by the stationary inboard seal carrier 156 because if moved far enough, the stationary inboard seal carrier 156 will contact the second pin end 144, which will prohibit further movement in that direction. Similarly, the seal 32 is limited in its movement toward the pump housing 22 by the second portion 105 of the spring holder 58 because if moved far enough, the second portion 105 of the spring holder 58 will contact the second pin end 144, which will prohibit further movement in that direction.

Even with its movement limited as herein described, however, the seal 32 is able to move a distance D between the farthest limits of its motion toward and away from the seal housing 22. In some embodiments, the distance D can be up to 0.25 inch or more. Throughout such movement, the inboard seal surface maintain sealed engagement, due to the force F exerted by the springs 110 in the spring holder 58. Thus, fluids do not leak from the seal during adjustment of the seal. It is this freedom of movement, without breaking the inboard or outboard seals, that allows adjustment of the shaft 30 and seal 32 to accommodate wear of the impeller 38, as discussed above.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. A double mechanical seal assembly for sealing around the shaft of a centrifugal pump, the centrifugal pump having a pump frame, the seal assembly comprising:
an annular shaft sleeve that surrounds a portion of the shaft, the annular shaft sleeve having an inner surface with a notch, the notch corresponding to a key on the shaft that engages the notch to transmit torque from the shaft to the shaft sleeve;
an annular seal sleeve that surrounds at least a portion of the shaft sleeve and is engaged with the shaft sleeve so that as the shaft and the shaft sleeve rotate, the seal sleeve rotates;
a rotating inboard seal and a rotating outboard seal each having a rotating seal face and operably associated with the shaft sleeve so that as the shaft sleeve rotates, the rotating inboard seal and the rotating outboard seal rotate;
a stationary inboard seal and a stationary outboard seal each having a stationary seal face, the stationary seal face of the stationary inboard seal sealingly engaged with the rotating seal face of the rotating inboard seal and the stationary seal face of the stationary outboard seal sealingly engaged with the rotating seal face of the rotating outboard seal, the stationary inboard seal and stationary outboard seal decoupled from the shaft and the shaft sleeve so that they do not rotate as the shaft and the shaft sleeve rotate.

2. The double mechanical seal assembly of claim 1, further comprising:
a gland plate surrounding a portion of the shaft sleeve and fixedly attached to the pump frame, the gland plate having a coolant inlet port for injection of coolant into the seal assembly to help cool the inboard and outboard seal faces, and an outlet port to permit egress of coolant after circulation through the seal assembly.

3. The double mechanical seal assembly of claim 2, further comprising:
a spring holder surrounding the seal sleeve and axially positioned between the inboard seals and the outboard seals with an inboard end contacting the stationary inboard seal, the spring holder having a plurality of springs extending axially from an outboard end thereof, an outboard end of the springs fixed in position relative to the gland plate so that the springs push the spring holder axially in an inboard direction, in turn pushing the stationary inboard seal into sealing engagement with the rotating inboard seal;
the springs having sufficient tension to maintain sealed engagement between stationary inboard seal and the rotating inboard seal as the spring holder moves axially in an inboard direction relative to the gland plate.

4. The double mechanical seal assembly of claim 3, wherein the springs have sufficient tension to maintain sealed engagement between stationary inboard seal and the rotating inboard seal as the spring holder moves up to at least about 0.25 inches in an inboard direction relative to the gland plate.

5. The double mechanical seal assembly of claim 1, wherein the stationary inboard seal face and the rotating inboard seal face are made of tungsten.

6. The double mechanical seal assembly of claim 1, wherein the stationary outboard seal face is made of carbon.

7. The double mechanical seal assembly of claim 1, wherein the rotating outboard seal face is made of tungsten.

8. A double mechanical seal assembly for sealing around the shaft of a centrifugal pump, the centrifugal pump having a pump frame, the seal assembly comprising:
an annular shaft sleeve that surrounds a portion of the shaft and that is mechanically engaged with the shaft so that as the shaft rotates the shaft sleeve rotates;
an annular seal sleeve that surrounds at least a portion of the shaft sleeve and is engaged with the shaft sleeve so that as the shaft and the shaft sleeve rotate, the seal sleeve rotates;
a rotating inboard seal and a rotating outboard seal each having a rotating seal face and operably associated with the shaft sleeve so that as the shaft sleeve rotates, the rotating inboard seal and the rotating outboard seal rotate;
a stationary inboard seal and a stationary outboard seal each having a stationary seal face, the stationary seal face of the stationary inboard seal sealingly engaged with the rotating seal face of the rotating inboard seal and the stationary seal face of the stationary outboard seal sealingly engaged with the rotating seal face of the rotating outboard seal, the stationary inboard seal and stationary outboard seal decoupled from the shaft and the shaft sleeve so that they do not rotate as the shaft and the shaft sleeve rotate; and
a gland plate surrounding a portion of the shaft sleeve and fixedly attached to the pump frame, the gland plate having a coolant inlet port for injection of coolant into the seal assembly to help cool the inboard and outboard seal faces, and an outlet port to permit egress of coolant after circulation through the seal assembly.

9. The seal assembly of claim 8, wherein the annular shaft sleeve has an inner surface with a notch, the notch corresponding to a key on the shaft that engages the notch to transmit torque from the shaft to the shaft sleeve.

10. The seal assembly of claim 9, further comprising:
a spring holder surrounding the seal sleeve and axially positioned between the inboard seals and the outboard seals with an inboard end contacting the stationary inboard seal, the spring holder having a plurality of springs extending axially from an outboard end thereof, an outboard end of the springs fixed in position relative to the gland plate so that the springs push the spring holder axially in an inboard direction, in turn pushing the stationary inboard seal into sealing engagement with the rotating inboard seal;
the springs having sufficient tension to maintain sealed engagement between stationary inboard seal and the rotating inboard seal as the spring holder moves axially in an inboard direction relative to the gland plate.

11. The double mechanical seal assembly of claim 10, wherein the springs have sufficient tension to maintain sealed engagement between stationary inboard seal and the rotating inboard seal as the spring holder moves up to at least about 0.25 inches in an inboard direction relative to the gland plate.

12. The double mechanical seal assembly of claim 8, wherein the stationary inboard seal face and the rotating inboard seal face are made of tungsten.

13. The double mechanical seal assembly of claim 8, wherein the stationary outboard seal face is made of carbon.

14. The double mechanical seal assembly of claim 8, wherein the rotating outboard seal face is made of tungsten.

15. A double mechanical seal assembly for sealing around the shaft of a centrifugal pump, the centrifugal pump having a pump frame, the seal assembly comprising:
an annular shaft sleeve that surrounds a portion of the shaft and that is mechanically engaged with the shaft so that as the shaft rotates the shaft sleeve rotates;
an annular seal sleeve that surrounds at least a portion of the shaft sleeve and is engaged with the shaft sleeve so that as the shaft and the shaft sleeve rotate, the seal sleeve rotates;
a rotating inboard seal and a rotating outboard seal each having a rotating seal face and operably associated with the shaft sleeve so that as the shaft sleeve rotates, the rotating inboard seal and the rotating outboard seal rotate;
a stationary inboard seal and a stationary outboard seal each having a stationary seal face, the stationary seal face of the stationary inboard seal sealingly engaged with the rotating seal face of the rotating inboard seal and the stationary seal face of the stationary outboard seal sealingly engaged with the rotating seal face of the rotating outboard seal, the stationary inboard seal and stationary outboard seal decoupled from the shaft and the shaft sleeve so that they do not rotate as the shaft and the shaft sleeve rotate;
a gland plate surrounding a portion of the shaft sleeve and fixedly attached to the pump frame; and
a spring holder surrounding the seal sleeve and axially positioned between the inboard seals and the outboard seals with an inboard end contacting the stationary inboard seal, the spring holder having a plurality of springs extending axially from an outboard end thereof, an outboard end of the springs fixed in position relative to the gland plate so that the springs push the spring holder axially in an inboard direction, in turn pushing the stationary inboard seal into sealing engagement with the rotating inboard seal;
the springs having sufficient tension to maintain sealed engagement between stationary inboard seal and the rotating inboard seal as the spring holder moves axially in an inboard direction relative to the gland plate.

16. The double mechanical seal assembly of claim 15, wherein the springs have sufficient tension to maintain sealed engagement between stationary inboard seal and the rotating inboard seal as the spring holder moves up to at least about 0.25 inches in an inboard direction relative to the gland plate.

17. The double mechanical seal assembly of claim 15, wherein the annular shaft sleeve has an inner surface with a notch, the notch corresponding to a key on the shaft that engages the notch to transmit torque from the shaft to the shaft sleeve.

18. The double mechanical seal assembly of claim 17, wherein the gland plate has a coolant inlet port for injection of coolant into the seal assembly to help cool the inboard and outboard seal faces, and an outlet port to permit egress of coolant after circulation through the seal assembly.

19. The double mechanical seal assembly of claim 15, wherein the stationary inboard seal face and the rotating inboard seal face are made of tungsten.

20. The double mechanical seal assembly of claim 15, wherein the stationary outboard seal face is made of carbon.

21. The double mechanical seal assembly of claim 15, wherein the rotating outboard seal face is made of tungsten.

22. A stuffing box for a centrifugal pump, the stuffing box comprising:
an inboard side for engagement with a pump housing of the centrifugal pump;
an outboard side opposite the inboard side; and
a passageway between the inboard side and outboard side of the stuffing box, the passageway for insertion of the shaft and a portion of the seal assembly of claim 1, the passageway having an inner passageway surface and comprising:
ribs formed in the inner passageway surface and extending inwardly from the inner passageway surface toward the shaft, the ribs arranged circumferentially around the inner passageway surface.
